(19) United States
(12) Patent Application Publication
(10) Pub. No.: US 2011/0070420 A1
(43) Pub. Date: Mar. 24, 2011

(54) NONWOVEN FIRE BARRIER WITH ENHANCED CHAR PERFORMANCE

(75) Inventors: Sang-Hoon Lim, Kennesaw, GA (US); Andrea Piana, Atlanta, GA (US)

(73) Assignee: TINTORIA PIANA US, INC., Cartersville, GA (US)

(21) Appl. No.: 12/906,524

(22) Filed: Oct. 18, 2010

Related U.S. Application Data
(63) Continuation-in-part of application No. 12/817,775, filed on Jun. 17, 2010.
Application No. 12/817,775 is a continuation-in-part of application No. PCT/US2010/047807, filed on Sep. 3, 2010.
(60) Provisional application No. 61/243,580, filed on Sep. 18, 2009.

(51) Int. Cl. D04H 13/00; B32B 5/26; D06M 13/00; B05D 3/00

(52) U.S. Cl. 428/219; 442/414; 442/392; 442/389; 427/324; 427/296

(57) ABSTRACT

A nonwoven is formed from one or more performance enhancing fibers together with one or more cellulosic fibers. The nonwoven could include low melting fibers for holding the nonwoven together on melting, and could include one or more optional fibers which impart a characteristic of interest to the nonwoven. The cellulosic fiber in the nonwoven is treated with fire resistant chemicals. The nonwoven has enhanced fire barrier performance, such as char elongation and char strength.

### CROSS-REFERENCE TO RELATED APPLICATIONS

This application claims priority to U.S. Provisional Patent Application 61/243,580 filed on Sep. 18, 2009, which is herein incorporated by reference. This application is also a continuation-in-part (CIP) application of U.S. patent application Ser. No. 12/817,775 filed Jun. 17, 2010, and the complete contents of that application is herein incorporated by reference. In addition, the application is a CIP application of International Patent Application PCT/US2010/047807 filed Sep. 3, 2010, and the complete contents thereof is herein incorporated by reference.

### FIELD OF THE INVENTION

The present invention is related to a nonwoven fire barrier comprised of a blend of fibers. More particularly, the main components of the nonwoven fire barrier are flame retardant (FR)-treated cellulosic fiber and performance-enhancing fiber, which is basalt fiber, glass fiber, oxidized polyacrylonitrile (PAN) fiber, aramid fiber or a mixture of these. The nonwoven fire barrier produced is cost-effective and has a variety of uses including without limitation use in mattresses and upholstered furniture.

### BACKGROUND

There has been an increasing demand for fire barrier products for use in mattresses and upholstered furniture. For example, the new U.S. federal open-flame mattress standard (CPSC 16 CFR Part 1633) has created a new demand for flame retardant (FR) fibers in the mattress industry. A number of companies have been developing nonwoven fire barriers to meet the federal standard. Examples of the approaches now being used are described in the following recently issued patents.

U.S. Pat. No. 7,410,920 (Davis) describes a nonwoven fire barrier consisting of charring-modified viscose fibers (Visil®) with less than 5% of polymers made from halogenated monomers.

U.S. Pat. No. 7,259,117 (Mater et al.) discloses a nonwoven high-loft fire barrier for mattresses and upholstered furniture. The high-loft nonwoven is composed of melamine fiber alone or in conjunction with other fibers.

There are a number of manufactured FR fibers, i.e., FR compound is added to polymer dope and extruded or the polymer backbone is modified to give flame retardancy. Manufactured FR fibers include aramids (Nomex® and Kevlar®), polyimide fibers (Ultem® polyetherimide and Extem® amorphous thermoplastic polyimide fibers), melamine fiber (Basofil®), halogen-containing fibers (Saran® fiber, modacrylics), polyphenylene sulfide fibers (Diofort®), Oxidized polyacrylonitrile fibers (Pyron® and Panox®), cured phenol-aldehyde fibers (Kynol® novoloid fiber), phosphorous FR-containing rayon fibers (Lenzing FR®, Shangdong Helon's Anti-frayon®), and silica-containing rayon fibers (Visil®, Daiwabo's FR Corona® fibers, Sniace's FR fiber, and Shangdong Helon's Anti-fcell®).

Despite their advantages, manufactured FR fibers are expensive. From an economic perspective, most of them are not suitable for mattresses and upholstered furniture due to their high costs. For the mattress and upholstered furniture industries, the most cost-effective commonly available FR fibers are FR-treated cotton fiber and FR-treated rayon fiber that are produced by post FR chemical treatment of cotton and rayon fibers. A variety of FR-treated cellulosic fibers are commercially available from Tintoria Piana US, Inc. (Cartersville, Ga., USA). The char forming property of these FR-treated cellulosic fibers make them suitable for fire barrier. However, it would be advantageous to have nonwoven fire barriers with superior fire resistant properties, but which are cost effective so that they would be suitable for use in mattresses, upholstered furniture, and in other applications.

### SUMMARY

An exemplary embodiment of the present invention is a nonwoven fire barrier containing one or more FR-treated cellulosic fibers and one or more performance-enhancing fibers, such as basalt fiber, glass fiber, oxidized PAN fiber, and aramid fiber. The nonwoven fiber barrier can be part of a multilayer structure in some applications. The uses of the nonwoven fire barrier include, but are not limited to, mattresses, furniture, building insulations, automotive, appliances, and wall panels for cubicles.

According to the invention, the addition of basalt fiber, glass fiber, oxidized PAN fiber, aramid fiber, or any combination of these fibers to FR-treated cellulosic fibers can dramatically improve the fire barrier performance, such as char strength and char elongation, which are critical properties of fire barrier nonwoven materials. The cellulosic fibers can be treated with flame retardant chemicals before or after formation of a nonwoven. In a particular embodiment, nonwoven products constructed from performance enhancing fibers (e.g., basalt fiber, glass fiber, oxidized PAN fiber, and aramid fiber) and untreated cellulosic fibers are treated with flame retardant chemicals wherein the resulting product has superior properties to nonwovens formed only from cellulosic fibers treated with flame retardant chemicals. Similarly, nonwoven products constructed from performance enhancing fibers (e.g., basalt fiber, glass fiber, oxidized PAN fiber, and aramid fiber) and FR treated cellulosic fibers have superior properties to nonwovens formed only from cellulosic fibers treated with flame retardant chemicals.

### DESCRIPTION OF THE DRAWINGS

FIG. 1a is a generalized schematic showing a one layer non-woven material according to the invention, and FIG. 1b is a generalized schematic showing a two layer configuration where, for example, a lower layer includes the non-woven material according to the invention together with an upper layer.

### DETAILED DESCRIPTION

The present invention generally relates to nonwoven compositions which contain FR-treated cellulosic fiber(s) and performance-enhancing fiber(s), such as basalt fiber, glass fiber, oxidized PAN fiber, aramid fiber or any combination of these. The cellulosic fibers can be rendered as FR cellulosic fibers before or after formation of the nonwoven composition.

A “nonwoven” is a manufactured sheet, web, or batt of natural and/or man-made fibers or filaments that are bonded to each other by any of several means. Manufacturing of nonwoven products is well described in “Nonwoven Textile Fabrics” in Kirk-Othmer Encyclopedia of Chemical Technology, 3rd Ed., Vol. 16, July 1984, John Wiley & Sons, p. 72˜124 and in “Nonwoven Textiles”, November 1988, Carolina Academic Press. Web bonding methods include mechanical bonding (e.g., needle punching, stitch, and hydro-entanglement); chemical bonding using binder chemicals (e.g., saturation, spraying, screen printing, and foam), and thermal bonding using binder fibers with low-melting points. Two common thermal bonding methods are air heating and calendaring. In air heating, hot air fuses low-melt binder fibers within and on the surface of the web to make high-loft nonwoven. In the calendaring process, the web is passed and compressed between heated cylinders to produce low-loft nonwoven.

In the practice of this invention, the fire barrier material is a nonwoven made from FR-treated cellulosic fiber and performance enhancing fiber selected from basalt fiber, glass fiber, oxidized PAN fiber, and aramid fiber. Basalt is a common extrusive volcanic rock. The manufacture of basalt fiber requires the melting of the quarried basalt rock to about 2,730° F. The molten rock is then extruded through small nozzles to produce continuous filaments of basalt fiber. The filaments are cut to desired length depending on final uses. Due to its superior thermal, physical, and chemical properties, it is often used for insulation, construction, automotive, and aircraft applications. Basalt fibers, glass fibers, oxidized PAN fibers, and aramid fibers are commercially available from a variety of sources.

In addition, other fibers (optional fibers) may be included in the nonwoven to achieve properties or characteristics of interest (e.g., color, texture, etc.), The nonwoven may be made using mechanical bonding, chemical bonding, or thermal bonding techniques. In an exemplary embodiment, thermal bonding using low melting point fibers (low-melt binder fiber) is employed to manufacture the nonwoven (i.e., the low melting point fibers melt at a lower temperature than the decomposition temperature of FR-treated cellulosic fibers and the melting point temperature of the performance enhancing fibers, and, after melting and diffusion into the fibers, serve to hold the FR-treated cellulosic fibers and performance enhancing fibers together in the nonwoven). The low-melt binder fibers can be any of those commonly used for thermal bonding and may preferably, but are not limited to, those that melt from 80 to 150° C. The nonwoven preferably has a basis weight of a basis weight ranging from 0.1˜5.0 oz/ft² (more preferably, 0.3˜2.0 oz/ft²; however, the basis weight of the nonwoven can vary widely depending on the intended application and desired characteristics of the nonwoven. The nonwoven is composed of the following components.

### Component 1 (Main Component): FR-Treated Cellulosic Fiber

FR-treated cellulosic fibers are produced by post FR chemical treatment on natural and manufactured cellulosic fibers. Methods for producing FR-treated cellulosic fibers are disclosed in U.S. Pat. Nos. 7,211,293 and 7,736,696 both of which are herein incorporated by reference. FR chemicals for the FR treatment include, but are not limited to, phosphorus-containing FR chemicals, sulfur-containing FR chemicals, halogen-containing FR chemicals, antimony-containing FR chemicals, and boron-containing FR chemicals. Examples of FR chemicals include, but not limited to, phosphoric acid and its derivatives, phosphonic acid and its derivatives, sulfuric acid and its derivatives, sulfamic acid and its derivatives, boric acid and its derivatives, borax, borates, ammonium phosphates, ammonium poly phosphates, ammonium sulfate, ammonium sulfamate, ammonium chloride, ammonium bromide. Natural cellulosic fiber includes, but not limited to, cotton, kapok, flax, ramie, kenaf, abaca, coir, hemp, jute, sisal, and pineapple fibers. Manufactured cellulosic fiber includes, but not limited to, rayon, lyocell, bamboo fiber, Tencel®, and Modal®. Manufactured FR cellulosic fiber includes, but not limited to, Lenzing FR®, Anti-frayon®, Anti-fcell®, Visil®, Daiwabo's FR Corona® fibers, and Sniace's FR rayon. In the practice of the invention, the cellulosic fiber may be rendered fire resistant before or after formation of the nonwoven.

### Component 2 (Main Component): Performance-Enhancing Fiber

Performance-enhancing fiber includes basalt fiber, glass fiber, oxidized PAN fiber, aramid fiber, or any combination of these fibers. Exemplary glass fibers include, but are not limited to, A-glass, E-glass, S-glass, C-glass, T-glass, AR-glass, etc. Examples of oxidized PAN fiber include, but not limited to, Pyron® and Panox®. Examples of aramid fiber include, but not limited to, Kevlar® and Nomex®.

### Component 3: Low-Melt Binder Fiber (or Powdered Polymer)

Low-melt binder fibers are synthetic fibers and are most widely used for thermal bonded nonwoven materials, although sometimes low-melt powdered polymers are used in thermal bonding. Any type of low-melt binder fibers used for thermal bonding process can be used for this application. These synthetic fibers can be either a bicomponent fiber or a fiber with low melting point. Low-melt binder fiber is optional for needle punched nonwoven and chemical-bonded nonwoven. For chemical bonding, binders include, but are not limited to, acrylic latexes, poly vinyl acetate copolymer, poly vinyl chloride copolymer, ethylene vinyl chloride, vinyl acetate-ethylene, acrylic copolymer, butadiene-acrylonitrile copolymers, acrylic binders, styrene acrylonitrile binder, styrene butadiene rubber binder, etc.

### Component 4: Optional Fiber

Optional fiber in the practice of this invention is additional fiber(s) added to the blend to provide desired characteristics or cost benefits. Optional fiber includes man-made fibers and natural fibers. These fibers can be untreated or FR chemical treated to increase flame retardancy. As optional fiber addition, any of these fibers or any combination of these can be added. Man-made fibers include, but are not limited to, polyester, nylon, acrylics, acetate, polyolefins, melamin fibers, elastomeric fibers, polybenzimidazole, aramid fibers, polyimide fibers, modacrylics, polyphenylene sulfide fibers, carbon fibers, Oxidized PAN fiber, Novoloid fibers, manufactured cellulosic fibers (rayon, lyocell, bamboo fiber, Tencel®, and Modal®), and manufactured FR cellulosic fibers (e.g., Visil®, Anti-fcell®, Daiwabo's FR Corona® fibers, Anti-frayon®, Sniace's FR rayon, and Lenzing FR®). Natural fibers include, but are not limited to, cotton, ramie, coir, hemp, abaca, sisal, kapok, jute, flax, kenaf, coconut fiber, pineapple fiber, wool, cashmere, and silk.

The principle constituents of the nonwoven fire barrier are components 1 and 2. The preferred amount of component 1 (FR-treated cellulosic fiber) is approximately 5˜99.99 wt. % and more preferably 50˜99.99 wt. %. The preferred amount of component 2 (performance-enhancing fiber) is approximately 0.01˜95 wt. % and more preferably at 0.01˜50 wt. % or 0.01˜20 wt. %

In exemplary embodiments, for thermal bonded nonwovens, component 3 (low-melt binder fiber) is required. However, for needle-punched and chemical-bonded nonwovens, component 3 is optional. The preferred amount of component 3 is approximately 1˜70 wt. % and more preferred at 5˜50 wt. %.

Those of skill in the art will recognize that the preferred amounts of components of 1, 2, and 3 are not limited to the ranges specified above, and that, depending on the application, manufacturing process, or other conditions, the amounts of components 1, 2 and 3 can be varied considerably within the practice of this invention.

Component 4 can be optionally added to the blend for providing desired characteristics (e.g., softness, texture, appearance, resilience, etc.) or cost benefit. Components 1 through 4 are blended at different ratios depending on final use and cost of the nonwoven. For example, to provide a better resilience property on the final high-loft nonwoven product and cost benefit, polyester fiber (as component 4) can be added to the blend. One possible example of blend ratio will be FR-treated cellulosic fiber:basalt fiber:polyester fiber:low-melt binder fiber=40-70:5-20:5-20:10-30, e.g., 60:10:10:20.

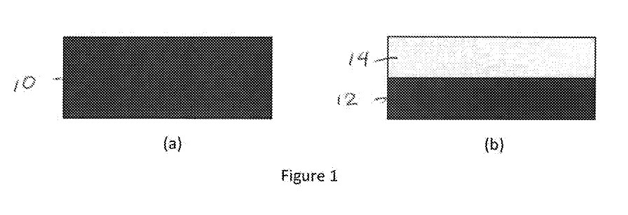

FIG. 1a shows nonwoven products with single blended layer 10 and FIG. 1b shows a nonwoven product as part of a multi layer system (see, e.g., two layers 12 and 14). The nonwoven products of FIG. 1a are as described above. However, in some applications, for desired characteristics (e.g., softness, texture, appearance, resilience, etc.) or cost benefit, a nonwoven with two layers of different blend combination can be made during nonwoven production. For example, in the generalized case shown in FIG. 1b, the bottom layer 12 blend could be made with combination of components 1, 2, 3, and 4, or components 1, 2, and 3, or components 1 and 2, as described above, while the top layer blend 14 could include differing amounts of the components (1-4), or could be a layer which only includes components 1, 3, and 4 without performance-enhancing fiber (component 2). As will be recognized by those of skill in the art, the variations on the configuration of the nonwoven in multilayer structures (e.g., FIG. 1b) are wide ranging and will depend on the fabrication and performance requirements desired.

As another method of producing a nonwoven (for both one layer blend and two layer blend) according to the invention, one or more untreated cellulosic fibers can be used in the nonwoven composition as component 1 (FR-treated cellulosic fibers) or as component 4 (optional fibers), with the nonwoven being subsequently treated with FR chemicals (i.e., the nonwoven can include untreated cellulosic fiber alone or together with FR-treated cellulosic fiber with the fibers being combined with performance enhancing fibers to make the nonwoven). Exemplary FR chemical application methods include, but are not limited to, padding, spraying, kiss roll application, foam application, blade application, and vacuum extraction application. After a desired amount of FR chemical formulation is applied on the nonwoven by these methods, the nonwovens are dried. For example, in the padding method, the nonwoven is immersed in FR chemical solution, the amount of FR chemical on the nonwoven is controlled by adjusting pressure of the padder rolls, and then the nonwoven is dried in an oven. Alternatively, an untreated cellulosic fiber could be combined with a performance enhancing fiber and an FR-treated cellulosic fiber to make a nonwoven in one layer and only the FR-treated cellulosic fiber and the performance enhancing fiber could be employed in another layer, etc.

### Example 1

Nonwoven web samples with different fiber compositions were prepared using a lab carding machine. For the samples, FR chemical (ammonium phosphate) treated rayon fiber, FR chemical (ammonium phosphate) treated cotton fiber, FR chemical (ammonium sulfate) treated cotton shoddy fiber, basalt fiber (diameter: 13 μm, length: 90 mm), glass fiber (E-glass, diameter: 13 μm, length: 90 mm), oxidized PAN (2 denier, 76 mm), Kevlar® (2 denier, 51 mm), Nomex® (2 denier, 51 mm), and low-melt binder fiber (LM) were used. For a fair comparison, the total weight of each blend was controlled to be the same at 10 grams.

The samples were completely burned to form a char using a burner horizontally located beneath the samples. Char strength and elongation were measured by a char tester. The tester is equipped with a loadcell connected to a vertically movable plate which presses char until its breakage. Elongation was measured in the unit of inches and char strength was measured as peak force in the unit of pounds (lb).

TABLE 1
Effect of Performance-enhancing fibers on FR-treated rayon fiber

| | Elongation | Peak |
|---|---|---|
| Fiber blends (wt. %) | (inch) | force (lb) |
| FR-treated rayon:LM = 80:20 | 0.359 | 4.21 |
| FR-treated rayon:basalt fiber:LM = 70:10:20 | 0.609 | 12.24 |
| FR-treated rayon:glass fiber:LM = 70:10:20 | 0.639 | 12.53 |
| FR-treated rayon:oxidized PAN:LM = 70:10:20 | 0.459 | 9.33 |
| FR-treated rayon:Kevlar ®:LM = 75:5:20 | 0.568 | 10.95 |
| FR-treated rayon:Nomex ®:LM = 75:5:20 | 0.428 | 9.36 |

TABLE 2
Effect of Performance-enhancing fibers on FR-treated cotton fiber

| | | Peak |
|---|---|---|
| | Elongation | force |
| Fiber blends (wt. %) | (inch) | (lb) |
| FR-treated cotton:LM = 80:20 | 0.317 | 1.47 |
| FR-treated cotton:basalt fiber:LM = 70:10:20 | 0.735 | 6.83 |
| FR-treated cotton:glass fiber:LM = 70:10:20 | 0.640 | 6.55 |
| FR-treated cotton shoddy*:LM = 80:20 | 0.290 | 1.45 |
| FR-treated cotton shoddy*:oxidized PAN:LM = | 0.445 | 6.07 |
| 60:20:20 | | |
| FR-treated cotton shoddy*:Kevlar ®:LM = 75:5:20 | 0.739 | 8.58 |

*Cotton shoddy is recycled cotton fiber from textile waste.

As demonstrated in Tables 1 and 2, the char elongation and char strength of FR-treated cotton and FR-treated rayon fibers increased dramatically by adding 5%, 10%, or 20% of performance-enhancing fibers. This improved char performance will help to prevent possible char breakage under severe flame conditions which would otherwise cause further flame propagation.

### Example 2

Thermal bonded high-loft nonwoven samples were prepared by using a commercial production line. FR cellulosic fibers and low-melt binder fiber (LM) with/without basalt fiber were blended at specific wt. % ratios. The blended fibers were carded to form a fiber web on a conveyor. The web is cross-lapped and passed through an oven to form a high-loft nonwoven. Various blend samples were prepared at different basis weight expressed as ounce per square foot (oz/ft²). The nonwoven samples were tested for char elongation and strength by the same method described in Example 1.

Table 3 shows char properties of FR cellulosic high-loft nonwovens which can be used, for example, in the mattress industry. All these nonwovens show char elongation below 0.4 inch and char strength below 2 lbs, which are pretty common for those products. Table 4 shows performance of some examples of the invented nonwoven blends containing basalt fiber (diameter: 13 μm, length: 90 mm). The results demonstrate significant increases in both char elongation and strength by the addition of basalt fiber.

TABLE 3
Properties of high-loft nonwoven made with FR cellulosic fibers and low-melt binder
fiber (LM).

| | Weight of | | |
|---|---|---|---|
| | nonwoven | Elongation | Peak force |
| Fiber blends (wt. %) | (oz/ft²) | (inch) | (lb) |
| Visil ®:LM = 80:20 | 0.80 | 0.365 | 0.92 |
| FR-treated rayon¹:Visil ®:LM = 40:40:20 | 0.77 | 0.334 | 1.10 |
| FR-treated cotton¹:Visil ®:LM = 40:40:20 | 0.80 | 0.352 | 0.60 |
| FR-treated rayon¹:FR-treated cotton¹:LM = 40:40:20 | 0.81 | 0.244 | 1.13 |
| FR-treated rayon¹:FR-treated cotton¹:LM = 40:40:20 | 1.01 | 0.284 | 1.23 |
| FR-treated rayon²:LM = 80:20 | 0.80 | 0.210 | 1.05 |
| FR-treated cotton²:Anti-fcell ®:LM = 40:40:20 | 1.13 | 0.336 | 0.86 |

¹FR treatment with ammonium phosphate
²FR treatment with ammonium sulfate

TABLE 4
Properties of high-loft nonwoven made with FR-treated cellulosic fibers, basalt fiber,
and low-melt binder fiber (LM).

| | Weight of | | |
|---|---|---|---|
| | nonwoven | Elongation | Peak force |
| Fiber blends (%) | (oz/ft²) | (inch) | (lb) |
| FR-treated cotton¹:basalt:LM = 60:10:30 | 0.50 | 0.425 | 4.60 |
| FR-treated cotton¹:basalt:LM = 60:10:30 | 0.76 | 0.600 | 8.33 |
| FR-treated cotton¹:basalt:LM = 60:10:30 | 0.90 | 0.641 | 9.65 |
| FR-treated cotton¹:basalt:LM = 55:15:30 | 0.50 | 0.513 | 6.05 |
| FR-treated cotton¹:basalt:LM = 55:15:30 | 0.76 | 0.548 | 14.28 |
| FR-treated cotton¹:basalt:LM = 55:15:30 | 0.92 | 0.594 | 16.61 |
| FR-treated cotton¹:FR-treated cotton shoddy¹*:basalt:LM = | 0.58 | 0.476 | 10.78 |
| 30:25:15:30 | | | |
| FR-treated cotton¹:FR-treated cotton shoddy¹*:basalt:LM = | 0.80 | 0.689 | 13.39 |
| 30:25:15:30 | | | |
| FR-treated cotton¹:FR-treated cotton shoddy¹*:basalt:LM = | 0.91 | 0.714 | 18.53 |
| 30:25:15:30 | | | |
| FR-treated cotton¹:FR-treated cotton shoddy¹*:basalt:LM = | 0.99 | 0.834 | 19.97 |
| 30:25:15:30 | | | |

¹FR treatment with ammonium sulfate
*Cotton shoddy is recycled cotton fiber from textile waste.

### Example 3

Nonwoven web samples with untreated rayon fibers were prepared using a lab carding machine. The weight of each nonwoven was controlled at 10 grams. The nonwoven samples were saturated in FR chemical solution (ammonium sulfate based) and the excess amount of FR chemical solution was removed by passing through padder rolls. The solid add-on of FR chemical on the nonwovens was controlled at 16% by adjusting pressure of the padder rolls. The FR-treated nonwovens were dried in an oven at 120° C. for 20 min. The nonwoven samples were tested for char elongation and strength by the same method described in Example 1.

TABLE 5
Effect of Basalt fiber on post FR-treated nonwoven

| Fibers (wt. %) | Elongation | |
|---|---|---|
| in nonwoven | (inch) | Peak force (lb) |
| Rayon = 100 | 0.421 | 2.84 |
| Rayon:basalt fiber = 90:10 | 0.628 | 7.16 |

As seen in Table 5, the char elongation and char strength of nonwoven made with rayon alone was improved dramatically by adding 10% of basalt.

### Example 4

Examples of two layer (or multilayer) nonwovens as depicted in FIG. 1b, include:
(a) a two layer blending composition where a 1 oz/ft² highloft nonwoven can have 0.5 oz/ft² bottom layer and a 0.5 oz/ft² top layer with the bottom layer blend ratio being FR-treated cotton fiber:basalt fiber:low-melt binder fiber at 60:20:20 and the top layer being FR-treated cotton fiber:low-melt binder fiber at 80:20.
(b) a two layer 1.1 oz/ft² highloft nonwoven can have 0.8 oz/ft² bottom layer and a 0.3 oz/ft² top layer with the bottom layer blend ratio being FR-treated cotton fiber:basalt fiber:low-melt binder fiber at 65:15:20 and the top layer being polyester fiber:low-melt binder fiber at 80:20:
(c) a two layer 1 oz/ft² highloft nonwoven can have 0.75 oz/ft² bottom layer and a 0.25 oz/ft² top layer with the bottom layer blend ratio being FR-treated cotton'fiber:oxidized PAN fiber:low-melt binder fiber at 50:30:20 and the top layer being polyester fiber:low-melt binder fiber at 80:20.
(d) a two layer 1 oz/ft² highloft nonwoven can have 0.75 oz/ft² bottom layer and a 0.25 oz/ft² top layer with the bottom layer blend ratio being FR-treated cotton fiber:Kevlar® fiber:low-melt binder fiber at 75:5:20 and the top layer being FR-treated cotton fiber:polyester fiber:low-melt binder fiber at 40:40:20.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A nonwoven, comprising:
flame retardant (FR)-treated cellulosic fiber; and
performance-enhancing fiber.

2. The nonwoven of claim 1, wherein the FR-treated cellulosic fiber is FR-treated natural cellulosic fiber, FR-treated manufactured cellulosic fiber, or any combination of these fibers.

3. The nonwoven of claim 1, wherein the performance-enhancing fiber is basalt fiber, glass fiber, oxidized polyacrylonitrile (PAN) fiber, aramid fiber or any combination of these fibers.

4. The nonwoven of claim 1, further comprising a low-melt binder fiber for thermal bonding of the nonwoven.

5. The nonwoven of claim 1, wherein the FR-treated cellulosic fiber and performance-enhancing fiber are mechanically bonded together.

6. The nonwoven of claim 1, wherein the FR-treated cellulosic fiber and performance-enhancing fiber are chemically bonded together.

7. The nonwoven of claim 1, further comprising one or more optional fibers which are different from said FR-treated cellulosic fiber and said performance enhancing fiber.

8. The nonwoven of claim 7 wherein said optional fibers are present in sufficient quantity to provide a characteristic to said nonwoven selected from the group consisting of softness, texture, appearance, resilience, and cost benefit.

9. The nonwoven of claim 1 wherein said nonwoven has a basis weight ranging from 0.1˜5.0 oz/ft².

10. The nonwoven of claim 1 wherein
said FR-treated cellulosic fiber is FR-treated natural cellulosic fiber, FR-treated manufactured cellulosic fiber, or any combination of these fibers,
said performance-enhancing fiber is basalt fiber, glass fiber, oxidized PAN fiber, aramid fiber or, any combination of these fibers, and said performance-enhancing fiber is present in said nonwoven at approximately 0.01˜30 wt. %.

11. The nonwoven of claim 10 further comprising low-melt binder fibers.

12. The nonwoven of claim 10 further comprising one or more optional fibers.

13. The nonwoven of claim 1 configured as a multilayer structure where at least one layer but not all layers includes said performance enhancing fiber.

14. The nonwoven of claim 1 configured as a multilayer structure where at least two different layers include differing compositions of said FR-treated cellulosic fiber and said performance enhancing fiber.

15. The nonwoven of claim 1 configured as a structure having two layers wherein said performance enhancing fiber is present only in one of said two layers.

16. A method of making a fire resistant nonwoven with enhanced char strength, comprising the steps of:
forming a nonwoven as a multilayer structure wherein one or more layers of said nonwoven include at least one untreated cellulosic fiber and at least one performance-enhancing fiber; and
applying one or more fire retardant chemicals to the nonwoven.

17. The method of claim 16 further comprising the step of passing the nonwoven through padder rolls.

18. The method of claim 16 wherein said step of applying is performed by padding, spraying, kiss roll application, foam application, blade application, or vacuum extraction application.

19. The method of claim 16 wherein said forming step forms a multilayer structure with at least two layers wherein said performance enhancing fiber is present only in one of said at least two layers.
